(19) United States
(12) Patent Application Publication
(10) Pub. No.: US 2009/0071261 A1
(43) Pub. Date: Mar. 19, 2009

(54) Mill Configured for a Thermo-mechanical Simulating Test System

(75) Inventors: Hong-chun LI, Jinan (CN); Chun-guang MENG, Jinan (CN); Wei-hua SUN, Jinan (CN); Bob de JONG, Wollongong (AU)

Correspondence Address: DOVAS LAW P.C., 307 BAINBRIDGE STREET, PHILADELPHIA, PA, 19147, US

(73) Assignee: JINAN IRON AND STEEL COMPANY LTD., Jinan (CN)

(21) Appl. No.: 12/017,998

(22) Filed: Jan. 22, 2008

(30) Foreign Application Priority Data
Sep. 17, 2007 (CN) 200710017082.0

(51) Int. Cl. G01N 3/08; B21B 38/06

(52) U.S. Cl. 73/818; 72/250; 72/237; 73/824

(57) ABSTRACT

Relocate the abstract to the last page of the application and replace the abstract with the following new abstract:

A mill configured for a thermo-mechanical simulating test system includes a stand with a strip entry disposed thereon for feeding strips; an upper roller and a lower roller disposed on the stand; devices for axial and radial positioning of the upper roller and the lower roller; a pressure sensor for testing rolling force disposed between the stand and at least one of the upper roller and the lower roller; a strip clamp disposed corresponding to the strip entry, wherein the strip clamp is removeably connected to a first coupling head of the thermo-mechanical simulating test system; a coupling mount connected to the stand and disposed generally oppositely to the strip entry on a side of the stand, wherein the coupling mount is removeably connected to a second coupling head of the thermo-mechanical simulating test system. The mill can be used alone or in combination with a thermo-mechanical simulating test system.

### FIELD OF THE INVENTION

The present invention relates to a mill, and in particular to a mill which can be either used alone or in combination with a thermo-mechanical simulating test system, such as a Gleeble system, in steel rolling tests.

### BACKGROUND OF THE INVENTION

With the rapid development of computer science, computer simulating technology has become the third most prevalent research method in the field of material study, under only experimental research and theory research. In order to improve techniques, product performance and usage safety, there is a need to utilize various different material simulating test technologies. By testing specimens in a thermo-mechanical simulating test system, material structure change rules and specimen performance in given environment can be quickly and precisely studied. This research method is especially advanced in heat working evaluation, new material studies and new technique development. Thus, computer simulating technology is becoming more and more important in the field of material engineering. The Gleeble thermo-mechanical simulating test system has dynamic thermo-mechanical simulation functionality, and is used widely in analyzing heat working performance in steel continuous casting, press working, heat treatment, welding and other processes. At present, simulating tests available on the Gleeble system are: tensile tests at normal and high temperature, forging and/or torsion tests at normal and high temperature, thermal fatigue resistance tests, high temperature plasticity tests, heat treatment simulation tests and welding simulation. However, material rolling tests, rolling wear tests and rolling force tests can not be performed using the Gleeble system, because there is no mill available at present for a rolling test.

### SUMMARY OF THE INVENTION

The present invention solves the deficiency of the prior art technology by providing a mill configured for a thermo-mechanical simulating test system, which can be either used alone or in combination with thermo-mechanical simulating test systems, such as a Gleeble system, so as to implement material rolling tests, rolling wear tests and rolling force tests.

The present invention provides a mill configured for a thermo-mechanical simulating test system, wherein the thermo-mechanical simulating test system comprises a first coupling head and a second coupling head, and wherein the mill comprises:

a stand with a strip entry disposed thereon for feeding strips;

an upper roller and a lower roller disposed on the stand;

devices for axial and radial positioning of the upper roller and the lower roller;

a pressure sensor for testing rolling force disposed between the stand and at least one of the upper roller and the lower roller;

a strip clamp disposed corresponding to the strip entry, wherein the strip clamp is removeably connected to the first coupling head of the thermo-mechanical simulating test system; and

a coupling mount connected to the stand and disposed generally oppositely to the strip entry on a side of the stand, wherein the coupling mount is removeably connected to the second coupling head of the thermo-mechanical simulating test system.

In order to save roller materials and reduce test costs, each of the upper roller and the lower roller comprises a roller shaft and a cylinder part removeably connected with the roller shaft, and wherein the mill further comprises support pedestals connected with the stand, and wherein both ends of each of the roller shafts are connected with the stand by the support pedestals; so that only the cylinder parts need to be replaced when replacing rollers.

Wherein the cylinder part is connected with the respective roller shaft via axial bonds, and wherein the support pedestals on both ends of the roller shafts comprise bearing supports. Alternatively, the cylinder part is connected with the respective roller shaft via bearings.

Wherein the support pedestals are mounted on the stand and slidably fitted thereon, and wherein the mill further comprises an adjusting device disposed on the stand for adjusting the width of a gap between rollers to accommodate strips with different thicknesses.

Wherein the adjusting device comprises pressing down bolts, a bottom end of each pressing down bolts extends through a top cover of the stand to press on the support pedestal of the upper roller, and the pressing down bolts capable of moving rotatably up-and-down therethrough by way of screw threads, such that the bottom ends of the pressing down bolts and the support pedestals of the upper roller form the radial positioning device for the upper roller; by adjusting the pressing down bolts, the support pedestals move accordingly, driving the upper roller to move up and down so as to adjust the width of a gap between the upper and lower rollers.

The mill further comprising follower gears disposed on the pressing down bolts and rotatably moveable up-and-down by way of screw threads, wherein the follower gears engage with a driving gear including a driving handle, and wherein the bottom ends of the pressing down bolts are connected with the support pedestals of the upper roller.

The bottom ends of the pressing down bolts press tightly on the support pedestals of the upper roller, and the mill further comprises balance springs disposed between the support pedestals of the upper roller and the support pedestals of the lower roller so as to prevent the support pedestals falling down from the upper roller; the balance springs work with the pressing down bolts to adjust the width of a gap between the rollers.

Wherein the stand comprises a base, and the pressing down bolts work with a piece of spacer disposed between at least one of the support pedestals and the base to adjust the width of a gap between the rollers; in addition, the width of a gap between the rollers may be adjusted by the coordination work of the pressing down bolts, the balance springs and the spacer.

Wherein the stand comprises pulling rods, studs comprising threads are disposed on opposing ends of each of the pulling rods, and an intermediate part of each of the pulling rods is rectangle shaped in order to withstand the strong pulling force occurring during a rolling test; the stand further comprises a top cover and a base, and the top cover and the base are fixed on opposing ends of the pulling rods by studs and nut connections; and the support pedestals of the upper and lower rollers are mounted between the pulling rods, so that the rollers can be easily detached.

The present invention has the following advantages: it can be either used alone or in combination with a Gleeble thermo-mechanical simulating test system to implement material rolling tests, rolling wear tests or rolling force tests with easy operation and excellent test results.

### BRIEF DESCRIPTION OF THE DRAWINGS

The foregoing Summary as well as the following detailed description will be readily understood in conjunction with the appended drawings which illustrate preferred embodiments of the invention. In the drawings:

FIG. 1 is a front cross-sectional view of a mill configured for a thermo-mechanical simulating test system according to the present invention;

FIG. 2 is a left view of the mill as shown in FIG. 1;

FIG. 3 is a front view of a stand of the mill as shown in FIG. 1;

FIG. 4 is a left view of the stand as shown in FIG. 3;

FIG. 5 is a cross-sectional view of the stand along 5-5 as shown in FIG. 3;

FIG. 6 is a structural view of a coupling mount of the mill as shown in FIG. 1;

FIG. 7 is a left view of the coupling mount as shown in FIG. 6;

FIG. 8 is a top view of the coupling mount as shown in FIG. 6;

FIG. 9 is a structural view of a strip clamp of the mill as shown in FIG. 1;

FIG. 10 is a left view of the strip clamp as shown in FIG. 9;

FIG. 11 is a front view of a mill configured for a thermo-mechanical simulating test system according to a second embodiment of the present invention;

FIG. 12 is a left view of the mill as shown in FIG. 11;

FIG. 13 is a structural view of the rollers of the mill as shown in FIG. 11;

FIG. 14 is a front view of a mill configured for a thermo-mechanical simulating test system according to a third embodiment of the present invention;

FIG. 15 is a left view of the mill as shown in FIG. 14;

FIG. 16 is a schematic view showing the mill in use as shown in FIG. 1; and wherein:

1 denotes a pulling rod; 2 denotes a top cover; 3 denotes a base; 4 denotes an upper roller; 5 denotes a lower roller; 6 denotes a cylinder part; 7 denotes a roller shaft; 8 denotes a side plate; 9 denotes an upper support pedestal; 10 denotes a pressing down bolt; 11 denotes a lower support pedestal; 12 denotes a balance spring; 13 denotes a piece of spacer; 14 denotes a coupling mount; 141 denotes a trapezoid shaped coupling portion; 142 denotes a connecting plate; 143 denotes a through hole; 15 denotes a strip clamp; 151 denotes a rectangle shaped center hole; 16 denotes an upper bearing support; 17 denotes a lower bearing support; 18 denotes a window; 19 denotes an axial positioning plate; 20 denotes a window; 21 denotes a positioning plate; 22 denotes a driving gear; 23 denotes a follower gear; 24 denotes a driving handle; 25 denotes an operating rod; 26 denotes a support pedestal.

### DETAILED DESCRIPTION OF THE PREFERRED EMBODIMENTS

### First Embodiment

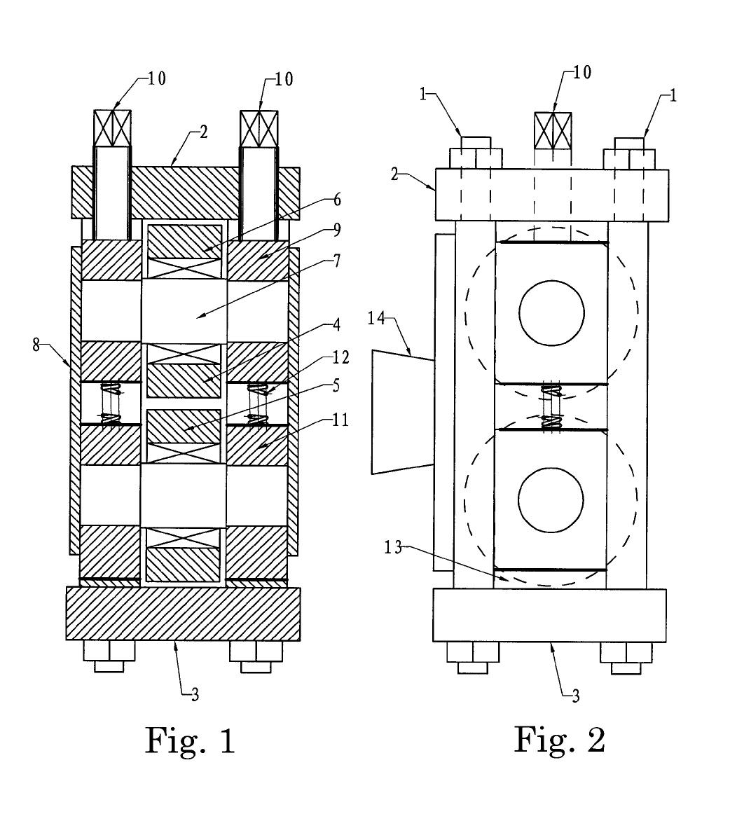

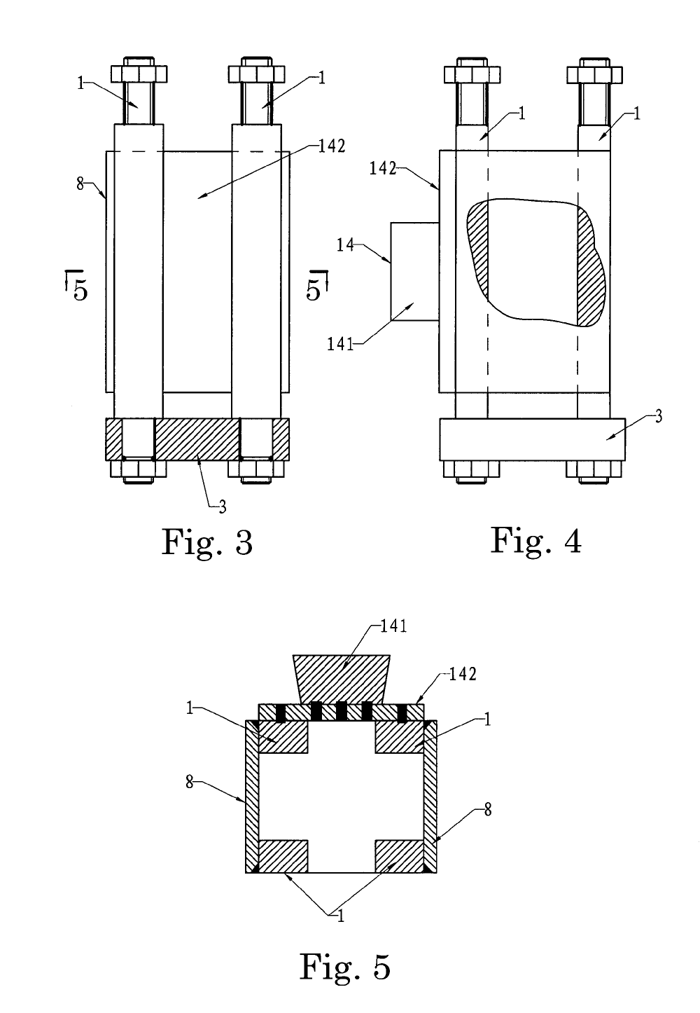

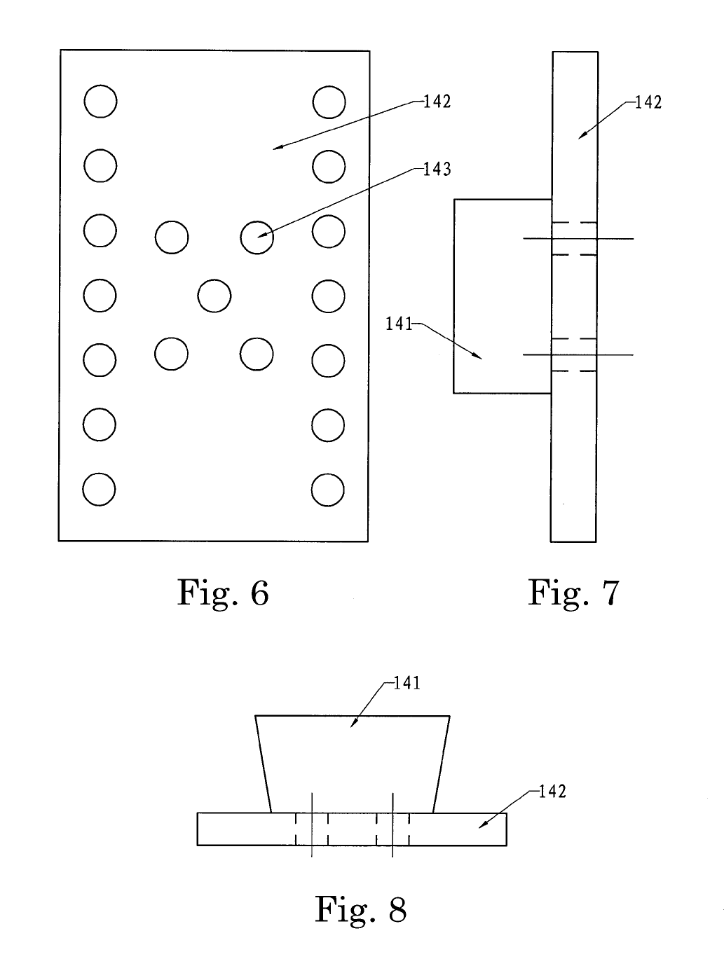

As shown in FIGS. 1 and 2, a mill configured for a thermo-mechanical simulating test system according to a first preferred embodiment of the present invention is shown. The mill comprises a stand, an upper roller 4 and a lower roller 5. As shown in FIGS. 3, 4 and 5, the stand comprises four pulling rods 1, a top cover 2 (as shown in FIG. 1) and a base 3. Studs comprising threads are disposed on opposing ends of each of the pulling rods 1, and an intermediate part of each of the pulling rods 1 is rectangle shaped in order to withstand the strong pulling force occurring during a rolling test. The base 3 of the stand is disposed and fixed at the bottoms of the pulling rods 1 by studs and nuts connections, that is, the four pulling rods 1 are connected by means of the base 3. Two side plates 8 are welded respectively on the outside of the pulling rods 1. Each of the upper roller 4 and the lower roller 5 comprises a roller shaft 7 and a cylinder part 6 removeably connected with the roller shaft 7, and wherein the mill further comprises support pedestals connected with the stand, and wherein both ends of each of the roller shafts 7 are connected with the stand by the support pedestals 9, 11. Only the cylinder parts 6 need to be replaced when replacing the upper roller 4 and/or the lower roller 5, so that the roller materials are saved and test costs are reduced. The upper support pedestals 9 and lower support pedestals 11 are mounted between pulling rods 1 and slidably fitted thereon. The side plates 8 are used for axial positioning of the rollers 4, 5. The top cover 2 is disposed above the upper roller 4 and fixed on top of the pulling rods 1 by studs and nuts connections. A bottom end of each pressing down bolts 10 extends through the top cover 2 of the stand to press on the upper support pedestal 9, and the pressing down bolts 10 capable of moving rotatably up-and-down therethrough by way of screw threads. Two pressing down bolts 10 are disposed respectively correspondingly to the ends of the rollers. Balance springs 12 are disposed between the upper support pedestals 9 and the lower support pedestals 11, and a piece of spacer 13 is disposed between the lower support pedestals 11 and the base 3. The coordination work of the pressing down bolts 10, the balance springs 12 and the spacer 13 enables the adjustment on the width of a gap between the upper roller 4 and the lower roller 5. The lower support pedestals 11 can be moved up and down by adjusting the thickness of the spacer 13 and the upper support pedestals 9 can be moved up and down by adjusting the pressing down bolts 10, wherein the support pedestals comprise bearing supports. A coupling mount 14 is welded at the pulling rods. As shown in FIGS. 6, 7 and 8, the coupling mount 14 comprises a trapezoid shaped coupling portion 141 and a connecting plate 142 which is integrally welded thereon. The connecting plate 142 and the pulling rods 1 are connected by plug welding via the through holes 143 disposed on the connecting plate 142. During the feeding of strips between the two rollers, since the coupling mount 14 in whole is under pressure and the trapezoid shaped coupling portion 141 mainly functions as connecting and positioning, only relatively weak pulling force occurs while pulling out strips, therefore, the plug welding between the trapezoid shaped coupling portion 141 and the connecting plate 142 can satisfy the resistance requirement.

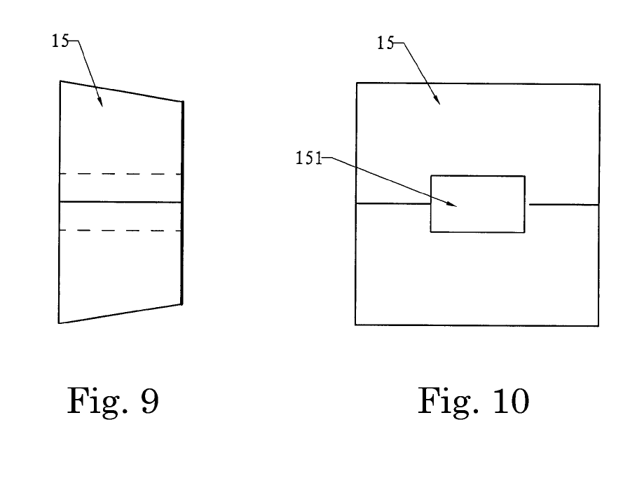

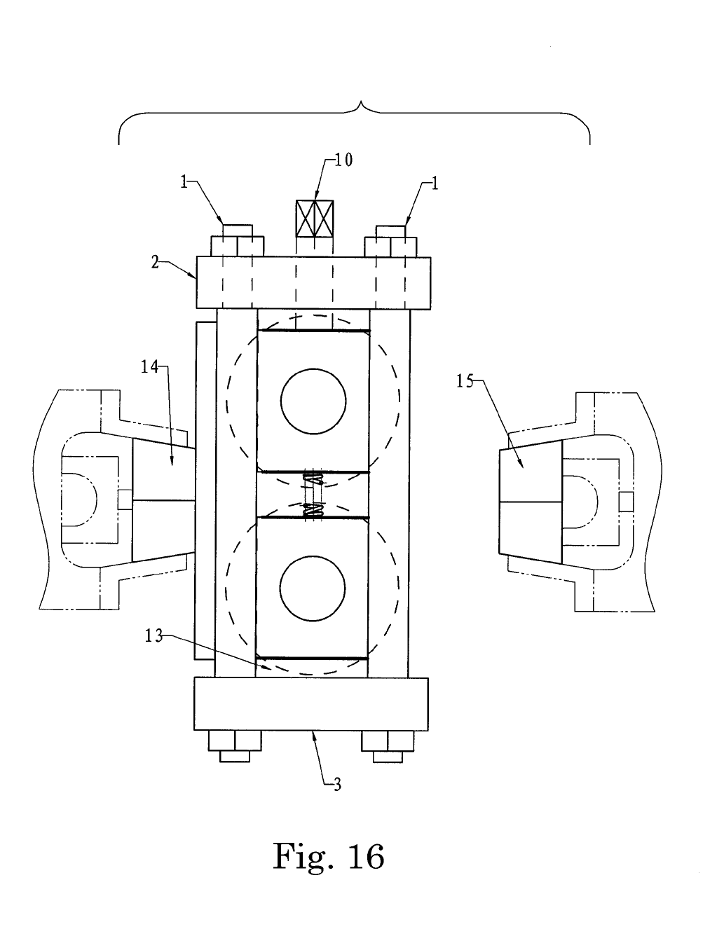

As shown in FIGS. 9 and 10, a strip clamp 15, which is removeably connected to a first coupling head of a Gleeble thermo-mechanical simulating test system, is in shape of a trapezoid, and includes two clamp portions, each of two strip slots mating with each other being disposed respectively on each of the two clamp portions. Whereby a rectangle shaped center hole 151 is formed by joining the two clamp portions for clamping strips. The outside of the trapezoid is shaped for connecting to the coupling head of a Gleeble thermo-mechanical simulating test system as shown in FIG. 16.

When performing a test, the cylinder parts 6 are placed onto the roller shafts 7, and the two rollers 4, 5 including the cylinder parts 6 and the roller shafts 7 are placed inside the stand from the stand top, the top cover 2 is closed and the nuts which are disposed on top of the pulling rods 1 are screwed down, and the pressing down bolts 10 are rotated downwardly so as to press tightly on the support pedestals of the upper roller. Then the coupling mount 14 is placed onto the coupling head of a Gleeble thermo-mechanical simulating test system and fastened. Further, the strip is placed into center hole of the strip clamp 15 and fastened as shown in FIG. 16; the journey of the coupling head, that is, the journey of the strip is adjusted and set in the Gleeble system. The strip is preferably a metal strip, and more preferably one of an aluminum strip, a copper strip and a steel strip. Alternatively, the strip may be formed of any suitable material.

After the installation and adjustment on the mill, strips are fed into rollers 4, 5 to begin the test. A pressure sensor is disposed either between the top of the upper support pedestals 9 and the top cover 2, or disposed between the bottom of the lower support pedestals 11 and the base 3 in order to observe and record in real-time changes of the rolling force during tests of different materials in different working conditions.

A temperature sensor can be disposed on the stand so as to observe and record temperature changes during tests of different materials in different working conditions. Alternatively, an infrared temperature measurement device can be used alone to measure the surface temperature of the rollers. Accordingly, the pressure sensor and the temperature sensor are connected to the display system of the Gleeble system so that the test data can be displayed to be viewed by a user.

### Second Embodiment

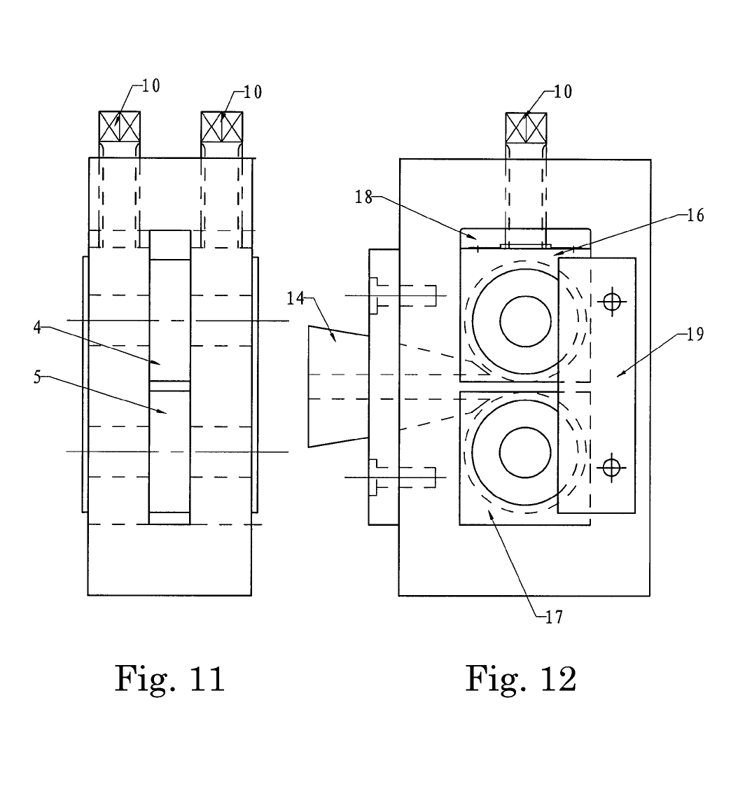

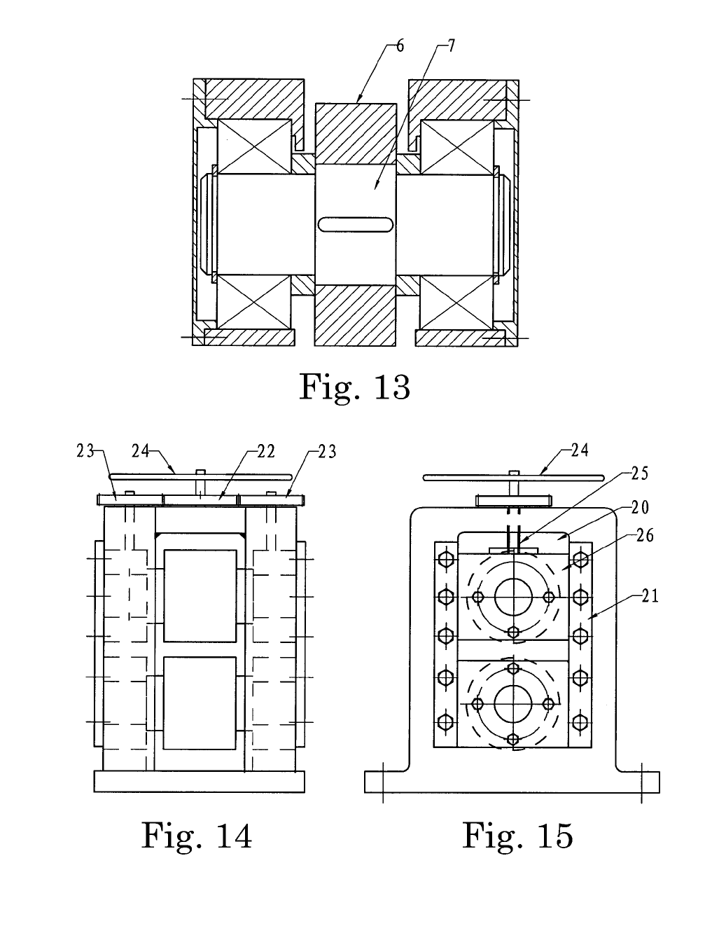

Referring to FIGS. 11 and 12, a second preferred embodiment of the present invention is shown which is different from the first embodiment in that no pulling rods are disposed on a stand of a mill configured for a thermo-mechanical simulating test system, the stand being integrally made up of two side plates, a front plate and a base. Windows 18 are disposed on the two side plates of the stand for placing rollers. A connecting plate of the coupling mount is connected at the back of the stand by means of countersink bolts. Referring to FIG. 13, the second embodiment of the present invention includes the cylinder part 6 connected with the respective roller shaft 7 via axial bonds with small sliding clearance. The two roller shafts 7 are connected in the windows 18 respectively by means of the upper bearing support 16 and the lower bearing support 17, enabling the two roller shafts 7 to move up and down along the windows 18. Axial positioning plates 19 are disposed on the two sides of the stand by bolts. After the bearing supports 16, 17 which are disposed at the two ends of the rollers have been disposed in the windows 18; the axial positioning plates 19 can be disposed thereon so as to limit the axial shift of the bearing supports.

The remaining structures of the second embodiment are similar to those of the first embodiment.

Because both ends of each of the roller shafts 7 are connected with the stand by the support pedestals, the height of the mill is increased. Therefore, it is less suitable for connection with a Gleeble system.

### Third Embodiment

Referring to FIGS. 14 and 15, a third preferred embodiment of the present invention is shown which is different from the first embodiment in that the stand is integral with windows 20 disposed on its two sides for disposing rollers. Axial positioning plates 21 are disposed outside the window by means of bolts. The adjusting device for adjusting the width of a gap between rollers comprises a driving gear 22 including a driving handle 24 and two follower gears 23 which are disposed on the two sides of the driving gear 22, wherein the follower gears 23 engage with the driving gear 22. The two follower gears 23 are mounted on operating rods 25 respectively by way of screw threads. The operating rods 25 are connected with the support pedestals 26 respectively which are disposed on the two ends of the upper roller. The driving handle 24 drives the driving gear 22 to rotated, and then the two follower gears 23 are driven to rotate in an opposite direction by the driving gear 22. Accordingly, the follower gears 23 drive the operating rods 25 to move up and down because they are screw thread fitted. Accordingly, the upper roller is driven to move up and down by its support pedestals, so that the width of a gap between the rollers is adjusted.

Of the above mention three embodiments, the first embodiment is most preferred, because it can be most easily detached and used in combination with a Gleeble system.

The adjusting device for adjusting the width of a gap between the rollers of the present invention is not limited by the described embodiments. Other embodiments may be provided wherein the width of a gap between the rollers is fixed and not adjustable. However, in such case the roller surface wear under different rolling forces can not be tested, therefore the test results are typically inferior.

The rollers can alternatively be formed as a single integral unit, but such may require more roller materials, and thereby increase material costs and overall test costs.

In addition, this type of mill can be used alone, not in combination with a Gleeble system, by connecting a suitable driving system with the strip clamp on the base, and connecting a pressure senor and a temperature sensor with a versatile digital meter.

1. A mill configured for a thermo-mechanical simulating test system, wherein the thermo-mechanical simulating test system comprises a first coupling head and a second coupling head, and wherein the mill comprises:
a stand with a strip entry disposed thereon for feeding strips;
an upper roller and a lower roller disposed on the stand;
devices for axial and radial positioning of the upper roller and the lower roller;
a pressure sensor for testing rolling force disposed between the stand and at least one of the upper roller and the lower roller;
a strip clamp disposed corresponding to the strip entry, wherein the strip clamp is removeably connected to the first coupling head of the thermo-mechanical simulating test system; and
a coupling mount connected to the stand and disposed generally oppositely to the strip entry on a side of the stand, wherein the coupling mount is removeably connected to the second coupling head of the thermo-mechanical simulating test system.

2. The mill according to claim 1, wherein each of the upper roller and the lower roller comprises a roller shaft and a cylinder part removeably connected with the roller shaft, and wherein the mill further comprises support pedestals connected with the stand, and wherein both ends of each of the roller shafts are connected with the stand by the support pedestals.

3. The mill according to claim 2, wherein the cylinder part is connected with the respective roller shaft via axial bonds, and wherein the support pedestals on both ends of the roller shafts comprise bearing supports.

4. The mill according to claim 2, wherein the cylinder part is connected with the respective roller shaft via bearings.

5. The mill according to claim 2, wherein the support pedestals are mounted on the stand and slidably fitted thereon, and wherein the mill further comprises an adjusting device disposed on the stand for adjusting the width of a gap between the rollers.

6. The mill according to claim 5, wherein the adjusting device comprises pressing down bolts, a bottom end of each of the pressing down bolts extends through a top cover of the stand to press on the support pedestal of the upper roller, and the pressing down bolts are capable of moving rotatably up-and-down therethrough by way of screw threads, such that the bottom ends of the pressing down bolts and the support pedestals of the upper roller form the radial positioning device for the upper roller.

7. The mill according to claim 6, further comprising follower gears disposed on the pressing down bolts and rotatably moveable up-and-down by way of screw threads, wherein the follower gears engage with a driving gear including a driving handle, and wherein the bottom ends of the pressing down bolts are connected with the support pedestals of the upper roller.

8. The mill according to claim 6, wherein the bottom ends of the pressing down bolts press tightly on the support pedestals of the upper roller; and the mill further comprises balance springs disposed between the support pedestals of the upper roller and the support pedestals of the lower roller.

9. The mill according to claim 8, wherein the stand comprises a base, and wherein a piece of spacer is disposed between at least one of the support pedestals and the base to adjust the width of a gap between the rollers.

10. The mill according to claim 2, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

11. The mill according to claim 3, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

12. The mill according to claim 4, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

13. The mill according to claim 5, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

14. The mill according to claim 6, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

15. The mill according to claim 7, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

16. The mill according to claim 8, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

17. The mill according to claim 9, wherein:
the stand comprises pulling rods, studs comprising threads are disposed on opposing ends of each of the pulling rods, and an intermediate part of each of the pulling rods is rectangle shaped;
the stand further comprises a top cover and a base, and the top cover and the base are fixed on opposing ends of the pulling rods by studs and nuts connections; and
the support pedestals of the upper and lower rollers are mounted between the pulling rods.

18. A combination mill and simulating test system comprising:
a thermo-mechanical simulating test system comprising a first coupling head and a second coupling head generally opposing the first coupling head; and
a mill comprising:
a stand with a strip entry disposed thereon for feeding strips;
an upper roller and a lower roller connected to the stand;
a pressure sensor for testing rolling force disposed between the stand and at least one of the upper roller and the lower roller;
a strip clamp removeably connected to the first coupling head of the thermo-mechanical simulating test system; and
a coupling mount connected to the stand, wherein the coupling mount is removeably connected to the second coupling head of the thermo-mechanical simulating test system.

19. The combination mill and simulating test system of claim 18, wherein the thermo-mechanical simulating test system comprises a Gleeble system.

20. A method for testing a strip of material comprising:
providing a simulating test system comprising a first coupling head and a second coupling head generally opposing the first coupling head;
providing a mill comprising:
a stand with a strip entry disposed thereon for feeding strips;
an upper roller and a lower roller connected to the stand; and
a pressure sensor for testing rolling force disposed between the stand and at least one of the upper roller and the lower roller;
providing a strip of material for testing;
connecting the strip to the first coupling head of the simulating test system;
connecting the stand to the second coupling head of the simulating test system;
feeding the strip of material between the upper roller and the lower roller; and
sensing a rolling force using the pressure sensor.
